(19) United States
(12) Patent Application Publication
(10) Pub. No.: US 2017/0102729 A1
(43) Pub. Date: Apr. 13, 2017

(54) MANUAL CALCULATING DEVICE

(71) Applicant: Dale Ylitalo, Cokato, MN (US)

(72) Inventor: Dale Ylitalo, Cokato, MN (US)

(21) Appl. No.: 14/878,168

(22) Filed: Oct. 8, 2015

(51) Int. Cl. G06C 1/00

(52) U.S. Cl. CPC G06C 1/00

(57) ABSTRACT

A manually operable calculating device is provided. The device includes a plurality of rods vertically disposed relative to one another. At least ten rings are slidably disposed on each of the plurality of rods. The at least ten rings include a first set of five rings including a first color and a second set of five rings including a second color. The plurality of rods each include a front surface opposite a rear surface. A plurality of numerals are disposed on the front surface and correspond to the number of rings. The rear surface is unnumbered.

### BACKGROUND OF THE INVENTION

The present invention relates to a manual calculating device and, more particularly, to a manual calculating device having a number line on a first side and a rekenrek on a second side.

An abacus is an early development of a manually operable calculating device comprising a plurality of spaced vertically disposed strings having thereon movable counters. Where a pupil can physically carry out a calculating function and see what he is doing, the mental process of absorbing and understanding the method of calculating and its result is greatly expedited. This has been attested to by teachers involved in teaching arithmetic to very early grade school children

### SUMMARY OF THE INVENTION

In one aspect of the present invention, a manually operable calculating device comprises: a plurality of rods vertically disposed relative to one another; a first stop member and a second stop member affixed to opposing ends of the plurality of rods; and at least ten rings slidably disposed on each of the plurality of rods and comprising a first set of five rings comprising a first color and a second set of five rings comprising a second color; wherein the plurality of rods each comprise: a front surface opposite a rear surface; a plurality of numerals on the front surface corresponding to the number of rings; an unnumbered length on the front surface extending from a last numeral thereon to provide a space for unused rings; and an unnumbered rear surface.

Every five counters or rings have a different color to readily display groups of five. For subtraction, let us assume there are ten counters at the left hand end of the rod with the numeral 10 on the rod being visible just to the right of the tenth counter on the numbered side. The calculation is to subtract five. The student moves five counters to the right and the numeral five appears on the rod just to the right of the remaining counters and that is the result or answer. On the unnumbered rekenrek side, five counters on the first rod may be moved to the right end. The five counters may be readily revealed due to the different colored counters. Five counters would be left on the left end providing the answer. Both mental and physical processes are used.

For addition of five and five on the numbered side, five counters would be moved to the left end of the rod and then five more are moved over with the result appearing just to the right of the tenth counter moved, the result being the numeral 10. On the unnumbered rekenrek side, five counters on a first rod may be moved to the left end of the first rod and then five counters on a second rod may be moved to the left end of the second rod. Alternatively, six counters on a first rod and four counters on a second rod may be moved, seven counters on a first rod and three counters on a second rod may be moved, and so on.

For multiplication on the numbered side, all counters are moved to the right of the rod. To multiply four by three, move three sets of four counters each to the left and the disclosed result is twelve shown at the right of the twelfth counter by the numeral on the rod adjacent thereto.

For division on the numbered side, with the counters at the right hand end of the rod, slide nine counters to the left as the dividend, with a divisor of three, separate the nine counters into groups of three to arrive at the quotient or the answer of three-there being three separated groups of three.

The operation carried out by the student at his desk, in a very real manner, supplements the visual operation of a blackboard demonstration with the mental comprehension of it. Thus the whole learning process for arithmetic is both supplemented and expedited

These and other features, aspects and advantages of the present invention will become better understood with reference to the following drawings, description and claims.

### BRIEF DESCRIPTION OF THE DRAWINGS

FIG. 1 is a perspective view of a first embodiment of the present invention;

FIG. 2 is a top view of the first embodiment of the present invention;

FIG. 3 is a front view of the first embodiment of the present invention;

FIG. 4 is a rear view of the first embodiment of the present invention;

FIG. 5 is a perspective view of a second embodiment of the present invention;

FIG. 6 is a top view of the second embodiment of the present invention;

FIG. 7 is a front view of the second embodiment of the present invention;

FIG. 8 is a rear view of the second embodiment of the present invention;

FIG. 9 is a perspective view of a third embodiment of the present invention;

FIG. 10 is a top view of the third embodiment of the present invention;

FIG. 11 is a front view of the third embodiment of the present invention; and

FIG. 12 is a rear view of the third embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

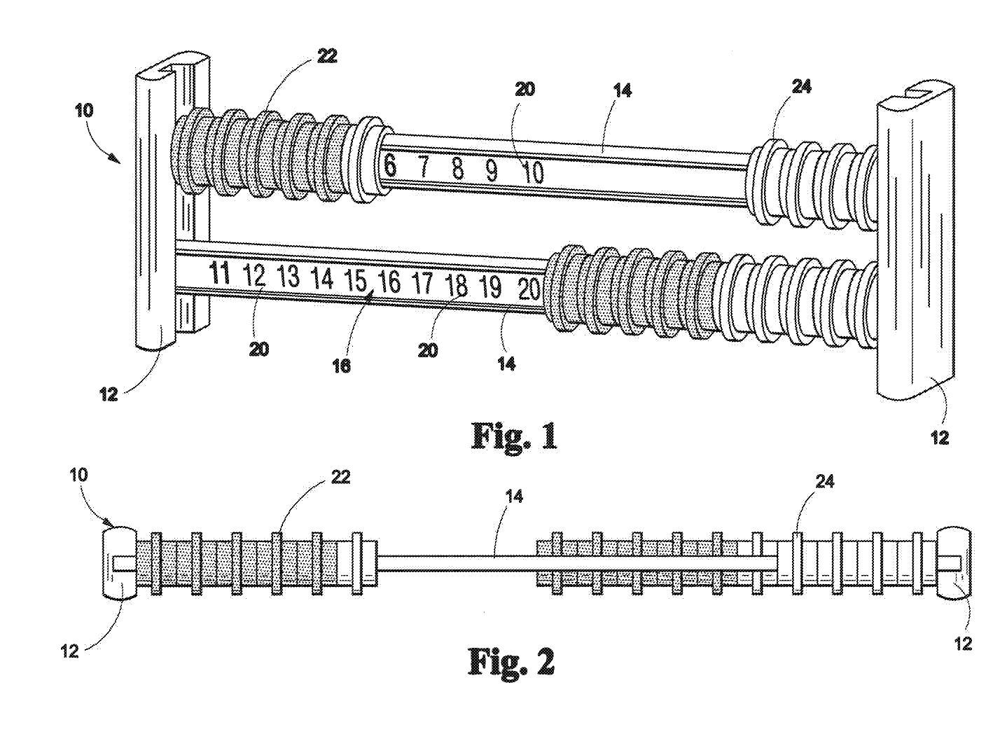

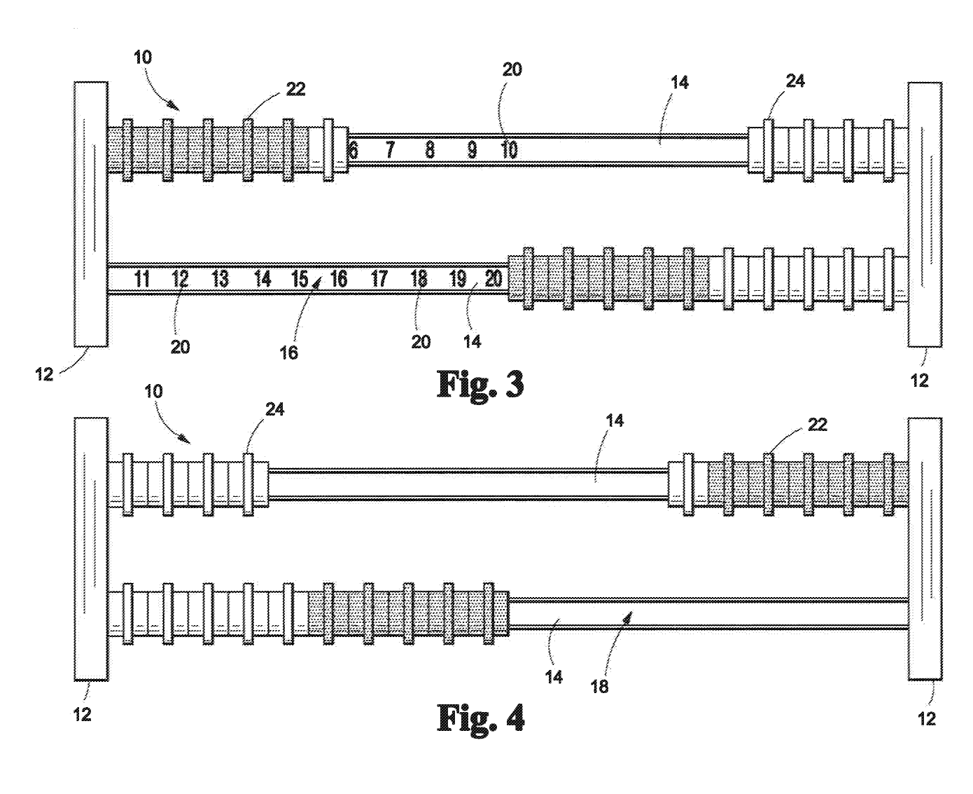

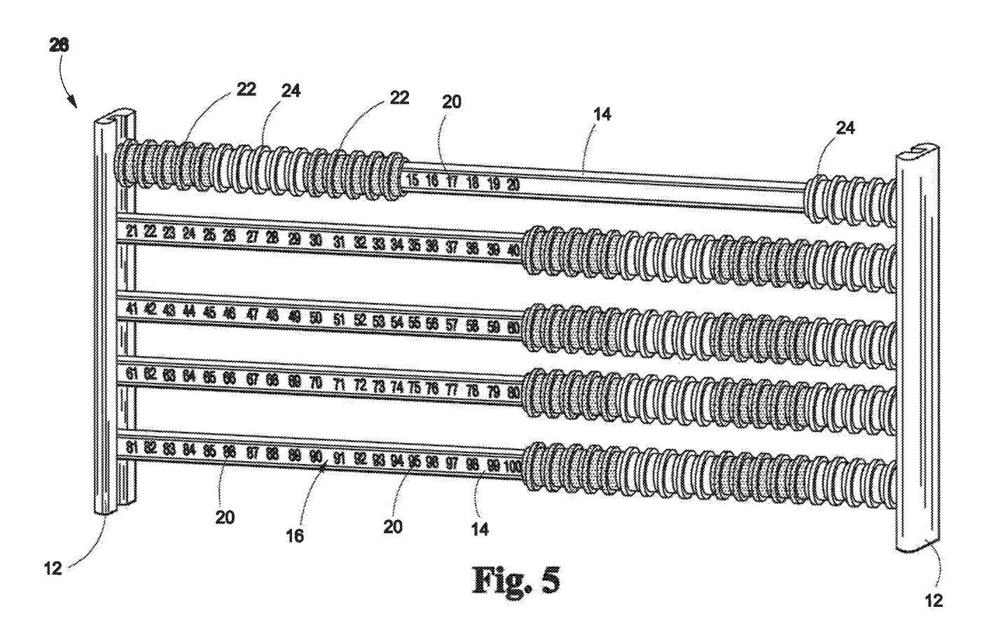

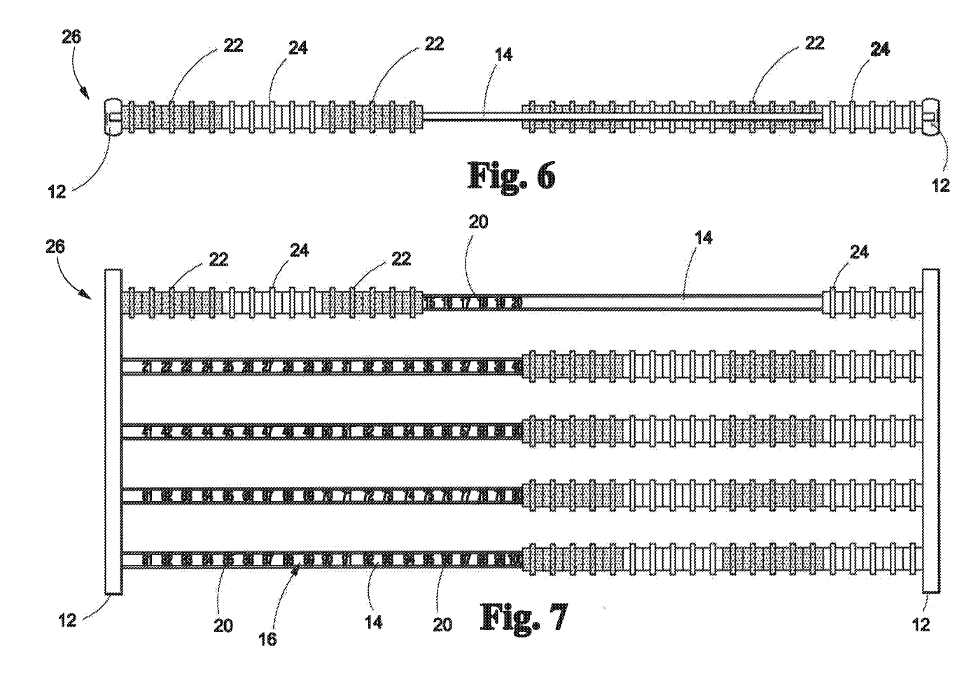

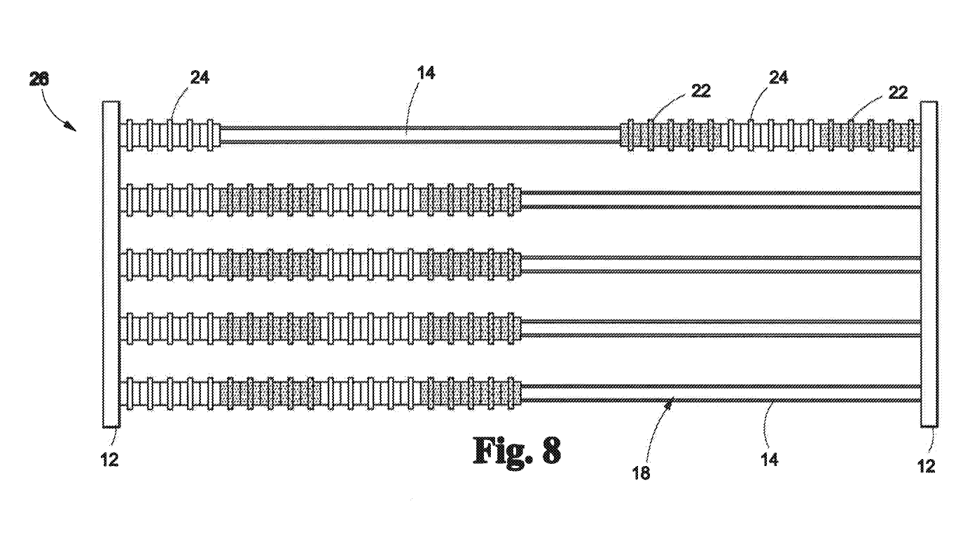

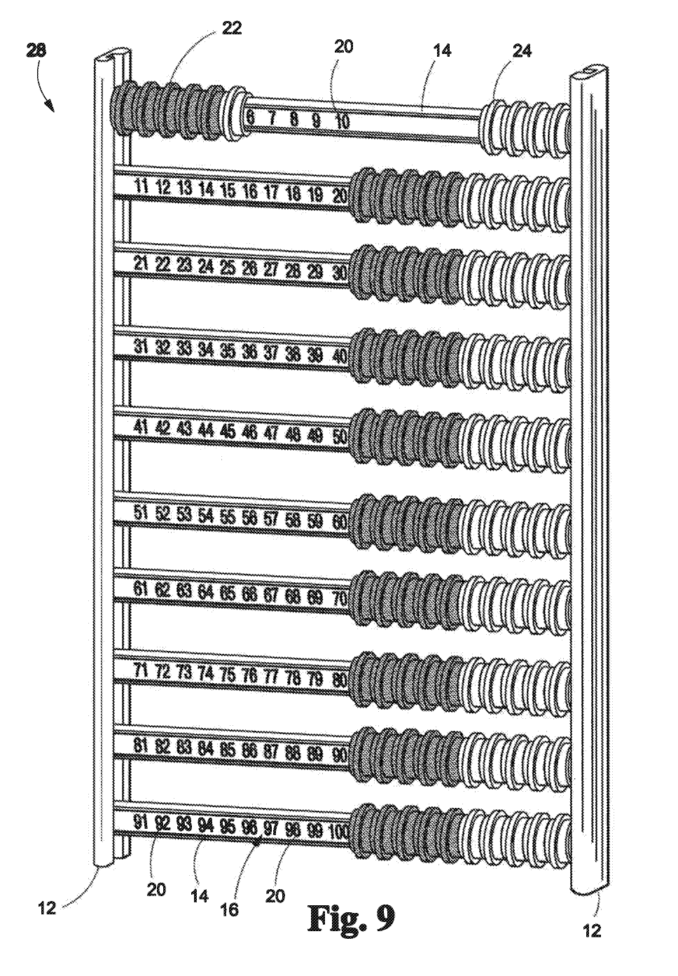

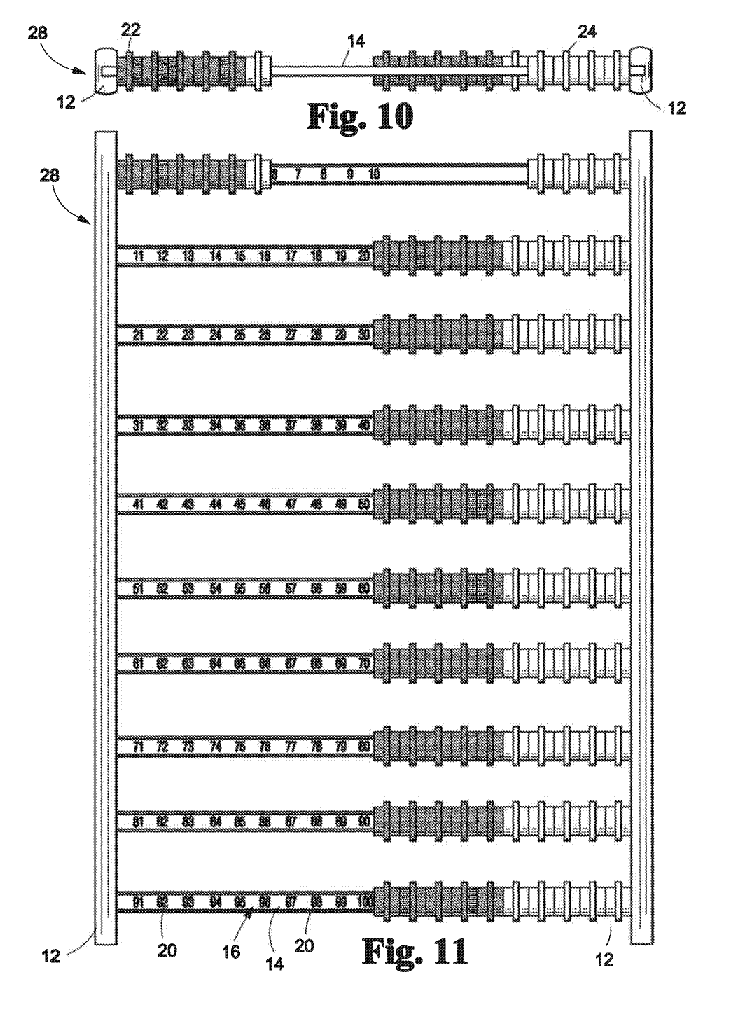

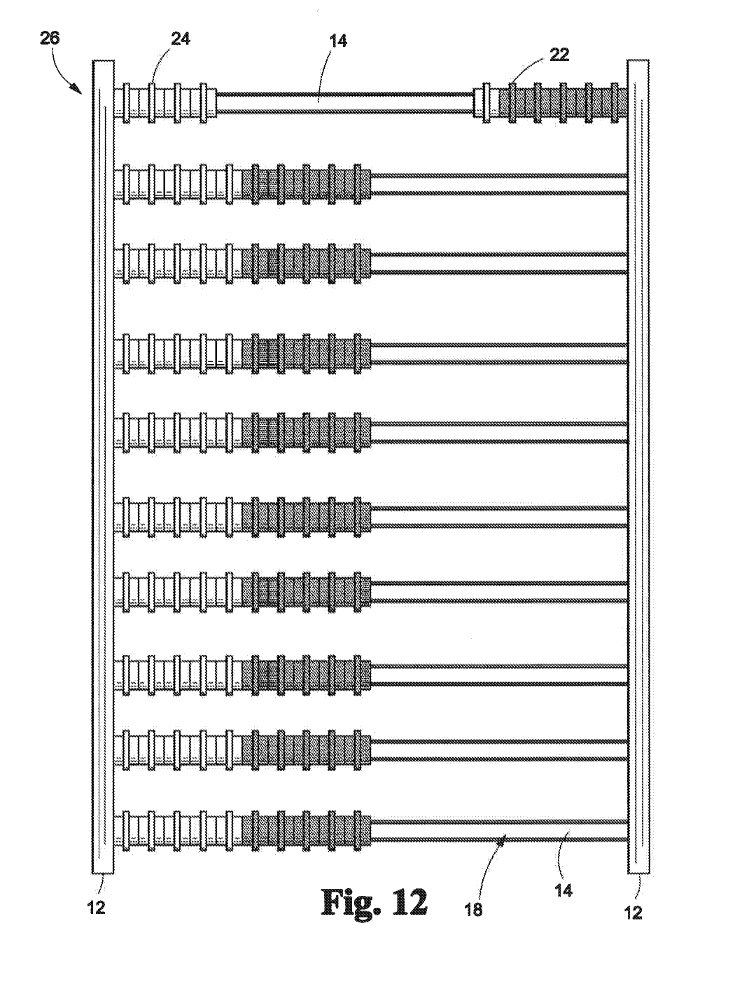

Referring to FIGS. 1 through 12, the present invention includes a manually operable calculating device 10. The device 10 includes a plurality of rods 14 vertically disposed relative to one another. A first stop member 12 and a second stop member 12 are affixed to opposing ends of the plurality of rods 14. At least ten rings 22, 24 are slidably disposed on each of the plurality of rods 14. The at least ten rings 22, 24 include a first set of five rings 22 including a first color and a second set of five rings 24 including a second color.

The plurality of rods 14 each include a front surface 16 opposite a rear surface 18. A plurality of numerals 20 are disposed on the front surface 16 and correspond to the number of rings 22, 24. The front surface 16 may further include an unnumbered length extending from a last numeral 20 thereon to provide a space for unused rings 22, 24. The rear surface 18 is unnumbered. On the front surface 16, when the rings 22, 24 are positioned to the left, the corresponding number for each ring 22, 24 will appear to the right thereof. The front side of the device 10 may thereby be used as a counter with a number line. The rear side of the device 10 may include an unnumbered surface, with the first set of five rings 22 including a first color and a second set of five rings 24 including a second color. Therefore, the rear side may be used as a rekenrek.

The rods 14 of the present invention may be made of wood or extruded as a plastic or a like member as may be desired. In certain embodiments, each of the rods 14 include a recessed slot along the length of the front surface 16. The numerals 20 are disposed within the recessed slot.

The stop members 12 of the present invention may be made of wood or extruded as a plastic or a like member as may be desired. The first stop member 12 and the second stop member 12 support the manually operable calculating device 10 in an upright position when the ends are resting on a surface. Further, the stop members 12 may have a width in which the sides of the manually operable calculating device 10 may lay flat on a surface and the rings 22, 24 are still slidable along the rods 14 and elevated above the surface. In certain embodiments, the stop members 12 may include recessed portions to receive the ends portions of the rods 14. Screws (not shown) may turn through aligning apertures of the stop member 12 and rod 14, thereby securing the rod 14 to the stop member 12.

Mounted to be movable on the rods 14 are rings 22, 24 or counters. The rings 22, 24 are formed of a rigid plastic material, metal or the like. The rings 22, 24 may conform to the rod 14 and are here illustrated as being circular in form and of a size to be readily slidable along the rod 14. For ease of engagement and manipulation each of said rings 22, 24 may have a central annular projecting rib. The rings 22, 24 correspond in number to the number of numerals appearing on the rod 14. As mentioned above, a first set of rings 22 include a first color and a second set of five rings 24 include a second color. Similar to a rekenrek, the first color may be red and the second color may be white.

The present invention may include multiple configurations. For example, a first embodiment of the device 10 may include a first rod 14 and a second rod 14. Numbers 1 through 10 may be imprinted on the front surface of the first rod 14 and numbers 11 through 20 may be imprinted on the front surface of the second rod 14. In such embodiments, the first and second rod 14 may each include a first set of five rings 22 having a first color and a second set of five rings 24 having a second color.

A second embodiment of the device 26 may include a first rod 14, a second rod 14, a third rod 14, a fourth rod 14, and a fifth rod 14. Numbers 1 through 20 may be imprinted on the front surface of the first rod 14, numbers 21 through 40 may be imprinted on the front surface of the second rod 14, numbers 41 through 60 may be imprinted on the front surface of the third rod 14, numbers 61 through 80 may be imprinted on the front surface of the fourth rod 14, and numbers 81 through 100 may be imprinted on the front surface of the fifth rod 14. In such embodiments, the five rods 14 may each include two sets of five rings 22 having a first color and two sets of five rings 24 having a second color. The sets of the first color and the second color may alternate.

A third embodiment of the device 28 may include ten rods 14. Numbers 1 through 10 may be imprinted on the front surface of the first rod 14, numbers 11 through 20 may be imprinted on the front surface of the second rod 14, numbers 21 through 30 may be imprinted on the front surface of the third rod 14, numbers 31 through 40 may be imprinted on the front surface of the fourth rod 14, numbers 41 through 50 may be imprinted on the front surface of the fifth rod 14, numbers 51 through 60 may be imprinted on the front surface of the sixth rod 14, numbers 61 through 70 may be imprinted on the front surface of the seventh rod 14, numbers 71 through 80 may be imprinted on the front surface of the eight rod 14, numbers 81 through 90 may be imprinted on the front surface of the ninth rod 14, and numbers 91 through 100 may be imprinted on the front surface of the tenth rod 14. In such embodiments, the ten rods 14 may each include a first set of five rings 22 having a first color and a second set of five rings 24 having a second color.

It should be understood, of course, that the foregoing relates to exemplary embodiments of the invention and that modifications may be made without departing from the spirit and scope of the invention as set forth in the following claims.

What is claimed is:

1. A manually operable calculating device comprising:
a plurality of rods vertically disposed relative to one another;
a first stop member and a second stop member affixed to opposing ends of the plurality of rods; and
at least ten rings slidably disposed on each of the plurality of rods and comprising a first set of five rings comprising a first color and a second set of five rings comprising a second color; wherein
the plurality of rods each comprise:
a front surface opposite a rear surface;
a plurality of numerals on the front surface corresponding to the number of rings;
an unnumbered length on the front surface extending from a last numeral thereon to provide a space for unused rings; and
an unnumbered rear surface.

2. The device of claim 1, wherein the first stop member and the second stop member support the manually operable calculating device in an upright vertical position or a horizontal position when resting on a surface.

3. The device of claim 1, wherein the first color is red and the second color is white.

4. The device of claim 1, wherein the plurality of rods each comprise a recessed slot along the length of the front surface, wherein the numerals are disposed within the recessed slot.

5. The device of claim 1, wherein the plurality of rods is two rods.

6. The device of claim 1, wherein the plurality of numerals on a first rod comprises 1 through 10 and the plurality of numerals on a second rod comprises 11 through 20.

7. The device of claim 1, wherein the at least ten rings is twenty rings comprising two first sets of five rings comprising the first color and two second sets of five rings comprising the second color, wherein the first sets and the second sets alternate along the rod.

8. The device of claim 7, wherein the plurality of rods is five rods.

9. The device of claim 8, wherein the plurality of numerals on a first rod comprises 1 through 20, the plurality of numerals on a second rod comprises 21 through 40, the plurality of numerals on a third rod comprises 41 through 60, the plurality of numerals on a fourth rod comprises 61 through 80, and the plurality of numerals on a fifth rod comprises 81 through 100.

10. The device of claim 1, wherein the plurality of rods is ten rods.
